(19) United States
(12) Patent Application Publication
(10) Pub. No.: US 2012/0184212 A1
(43) Pub. Date: Jul. 19, 2012

(54) APPARATUS AND METHOD FOR USING MULTIPLE DEVICES

(75) Inventors: Jong-Sung KIM, Gwacheon-si (KR); Jong-Ook JEONG, Seongnam-si (KR)

(73) Assignee: PANTECH CO., LTD., Seoul (KR)

(21) Appl. No.: 13/251,421

(22) Filed: Oct. 3, 2011

(30) Foreign Application Priority Data
Jan. 17, 2011 (KR) 10-2011-0004643

(51) Int. Cl. H04B 7/00; H04B 17/00

(52) U.S. Cl. 455/41.2; 455/67.11

(57) ABSTRACT

An apparatus and method for providing a communication service to a terminal having a specific identifier (ID), and an apparatus and method for receiving a communication service are disclosed. The method includes recognizing an attribute of a terminal, determining whether the communication service is appropriate for the terminal, and if it is determined that the communication service is appropriate, setting the terminal to an active mode.

### CROSS-REFERENCE TO RELATED APPLICATION

This application claims priority from and the benefit under 35 U.S.C. §119(a) of Korean Patent Application No. 10-2011-0004643, filed on Jan. 17, 2011, which is incorporated by reference for all purposes as if fully set forth herein.

### BACKGROUND

1. Field

This disclosure relates to a mobile communication system, and more particularly, to an apparatus and method for using multiple devices having a same identifier (ID).

2. Discussion of the Background

Subscriber identification module (SIM)/user identification module (UIM) cards are available and provide various operations, such as encoding, decoding, and enabling a prepaid card. Further operations include providing an electronic serial number (ESN), storing an ESN for communicating with a base station in a mobile communication terminal, or issuing, managing and administering an ESN separately from a portable terminal by storing the ESN in a smart card.

A SIM card can be attached to and detached from a portable terminal, and may include a microprocessor and a memory chip. The SIM card may store various pieces of information about a user. In addition to the SIM card, a universal subscriber identification module (USIM) card may be used as a smart card with a SIM card.

The USIM card is applied to a universal mobile telecommunication system (UMTS), which is a 3^{rd} generation communication service that allows users of portable terminals or computers to transmit wideband packet-based text, digitized audio or video, and multimedia data at rates of 2 Mbps or more, regardless of the users' location anywhere in the world. The USIM card can be embedded in an international mobile telecommunications-2000 (IMT-2000) service terminal and store user data along with secret authentication data. Each communication terminal may use such a USIM card with unique IDs for identifying their users assigned to the USIM cards according to each terminal used.

Recently-developed tablet personal computers (PCs), laptop computers, and smartphones enable internet service as well as voice communication, and thus a user may have multiple communication terminals that provide communication services. USIM information, with differing IDs are used with each of the communication terminals. Therefore, a user may have multiple subscriptions, at least one per terminal, thereby increasing the costs associated with possessing multiple communication terminals.

### SUMMARY

Exemplary embodiments provide an apparatus and method for using mobile terminals and a base station that communicates to the mobile terminals. The mobile terminals may be of a different type and have the same identifier (ID).

Additional features of the invention will be set forth in the description which follows, and in part will be apparent from the description, or may be learned by practice of the invention.

An exemplary embodiment provides a method for receiving a communication service in a terminal, the method including: recognizing an attribute and a type of the terminal; determining whether the communication service is appropriate for the terminal based on the attribute and the type; and if it is determined that the communication service is appropriate, setting the terminal to an active mode.

An exemplary embodiment provides a terminal to receive a communication service, including: an operation recognizer to recognize an attribute and a type of the terminal, and to determine whether the communication service is appropriate for the terminal based on the attribute and the type; and a mode setter to set the terminal to an active mode if it is determined that the communication service is appropriate.

An exemplary embodiment provides a method for providing a communication service to multiple terminals having a same specific identifier (ID), the method including receiving a request for providing a communication service to a terminal with the specific ID; selecting an appropriate terminal amongst the multiple terminals, for the communication service; and transmitting communication service data to the appropriate terminal.

An exemplary embodiment provides a base station apparatus to provide a communication service, including: a database (DB) configured to store information about at least one terminal, each having a specific identifier (ID); a communicator to communicate the communication service wirelessly with the at least one terminal; and a controller to select an appropriate terminal among the at least one terminals, if a request for providing a communication service to a terminal with the specific ID is received, wherein the communicator communicates the communication service to the appropriate terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain aspects of the invention.

FIG. 1 illustrates a mobile communication system according to an exemplary embodiment.

FIG. 2 is a schematic block diagram of a terminal according to an exemplary embodiment.

FIG. 3 is a flowchart illustrating a method for operating a terminal according to an exemplary embodiment.

FIG. 4 is a schematic block diagram of a base station according to an exemplary embodiment.

FIG. 5 is a flowchart illustrating a method for operating a base station according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

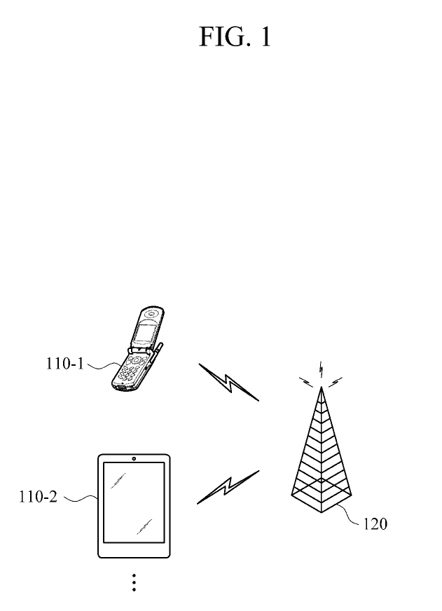

FIG. 1 illustrates a mobile communication system according to an exemplary embodiment.

Referring to FIG. 1, in a mobile communication system, at least two different types of terminals 110-1 and 110-2 are wirelessly connected to a base station 120. Herein, two terminals are described; however, one of ordinary skill in the art may utilize any number of terminals wirelessly connected to a base station 120. The terminals 110-1 and 110-2 each may be a smartphone, a personal digital assistant (PDA), a navigation terminal, a laptop computer, and a tablet personal computer (PC), and the like. The terminals 110-1 and 110-2 may have a subscriber identification module (SIM) and be authenticated by a mobile communication provider. The SIMs may be installed in the terminals 110-1 and 110-2 in the form of a is universal subscriber identification module (USIM), or stored in memories (virtual SIM) of the terminals 110-1 and 110-2. The same ID may be applied to each USIM card embedded in both terminals 110-1 and 110-2.

In addition the same communication service may be simultaneously provided to and used by terminals 110-1 and 110-2. For example, if a smartphone and tablet PC capable of voice communication are equipped with USIM cards having the same ID, the base station 120 recognizes the smartphone and the tablet PC as one terminal and transmits a paging signal for voice communication to both of the terminals. In addition, the same multimedia data may also be transmitted to different types of terminals equipped with USIM cards having the same ID. Thus, the same communication service may be simultaneously provided to multiple terminals, thereby leading to the waste of communication resources.

To prevent the same communication service from being simultaneously provided to multiple terminals employing USIM cards having the same ID, an apparatus and method for selectively providing an appropriate communication service based on the type of terminal used, a location of the terminal, a state of the terminal, and operational characteristics of the terminals is provided.

Thus, terminals 110-1 and 110-2 perform a selection operation to determine the appropriate communication service.

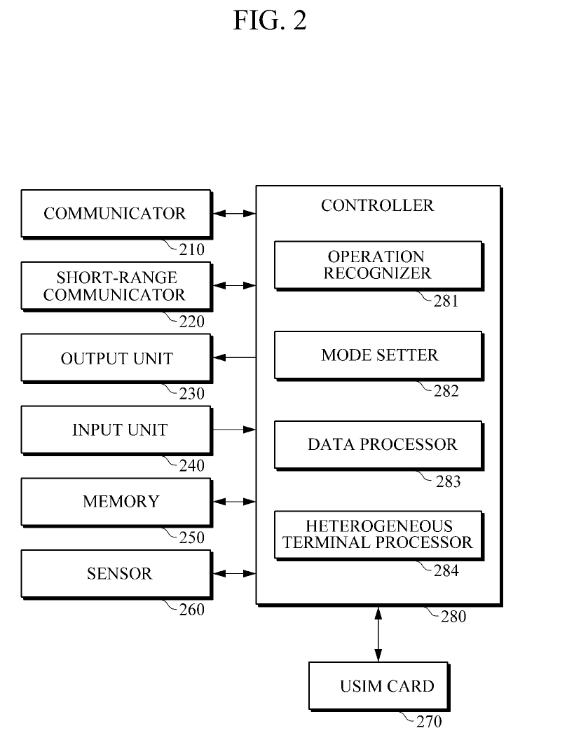

FIG. 2 is a schematic block diagram of a terminal according to an exemplary embodiment.

Referring to FIG. 2, a terminal (such as terminal 110-1 and 110-2 ) may include a communicator 210, a short-range communicator 220, an output unit 230, an input unit 240, a memory 250, a sensor 260, a USIM card 270, and a controller 280.

The communicator 210 processes a signal wirelessly received from a base station 120 and outputs the processed signal to the controller 280. The communicator 210 also processes an output signal received from the controller 280, so that the processed output signal may be wirelessly transmitted to the base station 120. The communicator 210 may include a radio frequency (RF) transceiver (not shown) that modulates/demodulates an RF signal and exchanges RF signals with the base station 120, and a baseband modulator/demodulator (not shown) that converts an RF signal output from the RF transceiver into a baseband signal to output the baseband signal as a digital information signal, or converts a digital information signal into an RF signal to output the RF signal to the RF transceiver.

The short-range communicator 220 allows communication to occur between multiple terminals, and may be a modem capable of performing Bluetooth® and/or wireless fidelity (Wi-Fi®) communication. Through the short-range communicator 220, the controller 280 may transmit an active/sleep-mode setting request signal, a location information request signal, and data to other terminals, for example, terminal of other types from the terminal.

The output unit 230 outputs a signal processed in the terminal, and may include a display unit (not shown), such as a liquid crystal display (LCD), and may output an image, text, or a voice. The output unit 230 may also include an audible output unit (not shown) that generates sound from data and outputs the sound through a speaker (not shown).

The input unit 240 receives information, and may include, for example, a key input unit (not shown) that generates key information every time a key is pressed, a touch sensor, and/or a mouse. Also, the input unit 240 may include a voice input unit (not shown) that receives a voice or sound through a microphone, and outputs a command in response thereto.

The memory 250 stores a variety of programs to operate the terminal, initial service data, and temporary data generated during operation. The memory 250 stores reference information to set the terminal to an active/sleep mode. The reference information may include information about a list of different types of terminals sharing the same ID. The reference information may also include stored active/sleep-mode setting information. For example, information for a table containing time-specific terminal mode information may be stored (Table 1).

TABLE 1

| Time | Active Terminal |
|---|---|
| 07:00~09:00 | Smartphone |
| 09:00~12:00 | Tablet PC |
| 12:00~13:00 | Smartphone |
| 13:00~18:30 | Tablet PC |
| 18:30~7:00 | Smartphone & |
| | Tablet PC |

The sensor 260 senses and outputs a real-time location and movement of the terminal, and the current time to the controller 280. For example, the sensor 260 may include a global positioning system (GPS) receiver that receives a terminal-location information signal transmitted by a GPS satellite. The sensor 260 is a well-known component and thus will not be described in detail. However, aspects need not be limited thereto such that the location and movement may be determined or received from other sources such as base station triangulation or a nearest or nearby server. Further, the sensor 260 may sense and output stored location and movement of the terminal, the sensing and storing occurring at regular or random intervals.

The USIM card 270 is a storage device, such as a smart card, and stores an ID for authenticating the terminal and information about a type of the terminal. Thus, the same ID may be given to multiple terminals with a USIM card 270. In this example, a USIM card is used as an example of a SIM, but the SIM may be stored in the memory 250 as a virtual SIM.

The controller 280 may be a hardware processor for controlling the above-described components, or a software module executed in the hardware processor. The controller 280 may include an operation recognizer 281, a mode setter 282, a data processor 283, and a heterogeneous terminal processor 284.

The operation recognizer 281 outputs information obtained by recognizing a current operation of the terminal. The recognition of a current operation of the terminal may be used to determine whether the operation performed in the terminal is appropriate at the current time or state. Based on the determination, an active/sleep mode may be selected for the terminal. For example, the operation recognizer 281 recognizes and outputs information that one of a voice communication service, a short message service (SMS), and a multimedia service is currently being requested for transmission and reception to the terminal via the communicator 210. The operation recognizer 281 recognizes and outputs a type of an application currently being executed in the terminal. Thus, if the operation recognizer 281 recognizes that the application requires a voice signal or multimedia information, the operation recognize 281 outputs this as recognition information. Further, the operation recognizer 281 may sense a location of the terminal through the sensor 260, and recognize and output information about a terminal type corresponding to the sensed location. Moreover, the operation recognizer 281 may recognize the current time through the sensor 260, and output type information about a terminal that is set to operate at the current time. For example, with reference to Table 1 above, the operation recognizer 281 may output information about a terminal set to operate at the current time, so if the current time is 12:30, the output recognizer 281 of a smart phone may output an awake mode setting.

The mode setter 282 sets the data processor 283 to the active/sleep mode according to the operation recognition information output from the operation recognizer 281.

Here, at least two pieces of operation recognition information may be output from the operation recognizer 281 to the mode setter 282, and the mode setter 282 sets the data processor 283 to a mode according to a determined priority. For example, if information that data currently received through the communicator 210 is multimedia data, with this recognition information being sourced from the operation recognizer 281, the mode setter 282 of the terminal, which may be a smartphone, may determine that multimedia is not appropriate for smartphone terminals to receive, and set the data processor 283 to the sleep mode. On the other hand, if a tablet PC is currently not available, and there is an instant desire to receive multimedia data, the mode setter 282 may set the data processor 283 of the smartphone to the active mode. This is because the data processor 283 has been set to the active mode through the input unit 240, and the active mode set through an input unit 240 may be determined to have a higher priority than a setting for smartphones, if the smartphone enters into sleep mode if receiving multimedia data communication.

The data processor 283 is set to the active or sleep mode by the mode setter 282 and selectively processes data according to the set mode.

The heterogeneous terminal processor 284 sets other terminals having the same ID to the active/sleep mode according to the mode set by the mode setter 282. The other terminals may be of a different type. For example, if the terminal is set to the active mode and different types of terminals are set to the active mode at the same time, the heterogeneous terminal processor 284 may detect information about another terminal that is set to the active mode among different types of terminals stored in the memory 250, and transmit the active-mode setting request signal to the other terminal.

If all, or some, of the other terminals are to operate in the sleep mode, the heterogeneous terminal processor 284 may transmit the sleep-mode setting request signal to the other terminals.

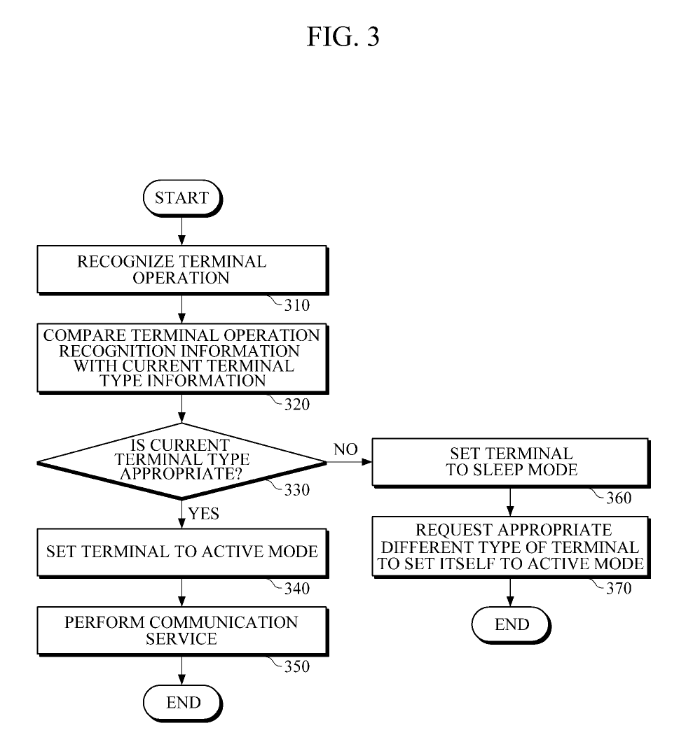

FIG. 3 is a flowchart illustrating a method for operating a terminal according to an exemplary embodiment.

Referring to FIG. 3, in operation 310, a terminal recognizes sensing information of the terminal, which may include a location of the terminal, the current time, the type of data communicated to the terminal or an operation state of the terminal (such as a service requested to be processed). For example, the terminal recognizes one of a voice communication service, an SMS, and a multimedia service as the communication service requested for transmission and reception to and from the terminal. Further, the terminal may recognize a type of an application currently executed by the terminal. Moreover, the terminal may recognize whether an application currently being executed requires a voice signal or multimedia information. And, the terminal may sense a location of the terminal, and may recognize a terminal type appropriate to receive the incoming data based on the sensed location. Also, the terminal may recognize the current time, and may recognize a type of a terminal set to operate at the current time. For example, with reference to Table 1 above, the terminal recognizes a terminal type that is set to be in the active mode at the current time.

The terminal compares the recognition information with terminal type information about the terminal, in operation 320, and determines whether data required for the communication service to be performed is appropriate for the type of the terminal, in operation 330.

If it is determined in operation 330 that the data required for the communication service is appropriate for the type of the terminal, the terminal is set to the active mode in operation 340. The terminal performs the communication service with a base station in operation 350. Although not shown in the drawings, if a different type or another terminal also is to be set to the active mode at the same time in order to perform the communication service, the terminal transmits the active-mode setting request signal to the different type or another terminal. Also, if all, or some of, the different types of terminals are to be set to the sleep mode, the terminal transmits the sleep-mode setting request signal to all, or some of, the different types of terminals.

If it is determined in operation 330 that the data required for the communication service is inappropriate for the type of the terminal, the terminal sets itself to the sleep mode in operation 360.

In operation 370, the terminal searches for a different type of terminal appropriate for the current communication service, and transmits the active-mode setting request signal to the searched terminal. Thus, the communication service with the base station is provided to the appropriate terminal.

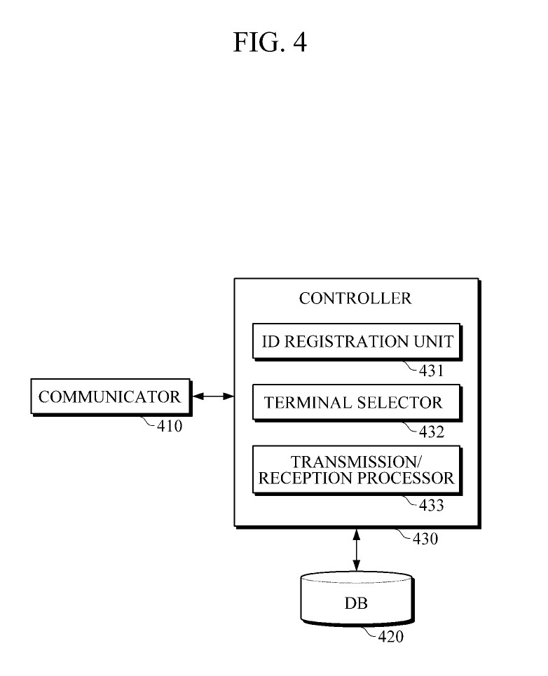

FIG. 4 is a schematic block diagram of a base station according to an exemplary embodiment.

Referring to FIG. 4, the base station 120 selects the appropriate terminal or terminals to provide a communication service.

A communicator 410 that processes a signal wireles sly received from multiple terminals to output the processed signal to a controller 430, and processes an output signal of the controller 430 to be a signal that can be wirelessly transmitted to the multiple terminals. The multiple terminals may be terminals 110-1 and 110-2 as described above. However, the multiple terminals may be any number of terminals, each with a USIM card having a shared ID. The communicator 410 may include an RF transceiver (not shown) that modulates/demodulates an RF signal and then exchanges RF signals with multiple terminals, and a baseband modulator/demodulator (not shown) that converts an RF signal output from the RF transceiver into a baseband signal to output the baseband signal as a digital information signal, and/or converts a digital information signal into an RF signal to output the RF signal to the RF transceiver (not shown).

A database (DB) 420 stores reference information for the controller 430 to select an appropriate terminal for a communication service. The reference information includes information about a list of different types of terminals equipped with USIM cards having the same ID, current mode information about the respective terminals, and data type information required for terminal selection by various communication services. The list information about the different types of terminals equipped with USIM cards having the same ID may include apparatus name and attribute information about the respective terminals. Also, the DB 420 may include the information in Table 1 above.

The controller 430 may be a hardware processor for controlling the above-described components, or a software module executed in the hardware processor. The controller 430 includes an ID registration unit 431, a terminal selector 432, and a transmission/reception processor 433.

The ID registration unit 431 registers information about multiple terminals (with the same ID associated with their SIM information) in the DB 420. Also, if data transmission to a terminal having a SIM having a specific ID is requested through the communicator 410, the ID registration unit 431 outputs respective names and attributes of the apparatuses having the same ID from the list information about the terminals equipped with SIMs having the same ID to the terminal selector 432. Also, the ID registration unit 431 receives mode setting information about whether a different type of terminal is currently in the active mode or the sleep mode and registers the mode setting information in the DB 420.

If a communication service to a terminal having a SIM card with a specific ID is requested, the terminal selector 432 selects an appropriate terminal for the requested communication service from among the multiple terminals, each having SIM cards with the specific ID. For example, the terminal selector 432 selects an appropriate terminal according to one of a voice communication service, an SMS, and a multimedia service being the communication service requested for transmission and reception to the terminal. Further, the terminal selector 432 may select an appropriate terminal based on a terminal type corresponding to a position of the terminal, which is communicated through the communicator 410. Moreover, the terminal selector 432 may select a terminal corresponding to a type of a terminal set to operate at the current time. For example, with reference to Table 1 above, a terminal set to operate at the current time may be selected by the terminal selector 432

According to terminal-selection result information output from the terminal selector 432, the transmission/reception processor 433 provides the requested communication service to the corresponding selected terminal.

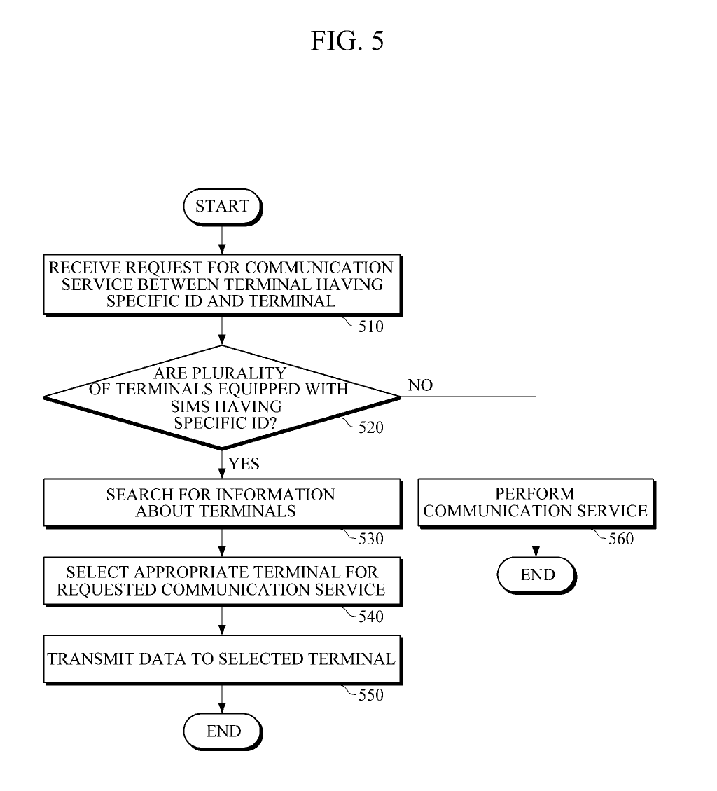

FIG. 5 is a flowchart illustrating a method for operating a base station according to an exemplary embodiment.

Referring to FIG. 5, in operation 510, a base station is requested to provide a communication service to a terminal equipped with a SIM having a specific ID. In operation 520, the base station determines whether different types of terminals equipped with SIM information having the specific ID are registered in a DB 420.

If it is determined in operation 520 that there are different types of terminals equipped with SIM cards with the specific ID, the base station searches for information about the different types of terminals having SIM cards with the specific ID, in operation 530. This search generates names and attributes of the respective terminals with SIM cards with the specific ID.

In operation 540, the base station selects an appropriate terminal for the requested communication service on the basis of the obtained information. Although not shown in the drawings, the base station may search for mode setting information about respective terminals registered in a DB 420, thereby selecting a terminal in the active mode. A detailed description of terminal selection is similar to the operation described in accordance with the terminal selector 432 of FIG. 4. In operation 550, the base station transmits data required for the requested communication service to the selected terminal.

If it is determined in operation 520 that there is only one terminal with SIM information having the specific ID, the base station provides the communication service to that terminal in operation 560.

In this disclosure, if multiple terminals use USIM cards having the same ID, communication services may be selectively configured. Thus, multiple terminals may be employed using only one ID. Therefore, a subscription cost to different communication services for different devices and/or type may be reduced. This may result in lesser costs to a consumer of communication services.

Also, communication services to one or some of the multiple types of terminals with a same ID may be realized, thereby preventing duplicated data being delivered to all of the multiple terminals.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for receiving a communication service in a terminal, the method comprising:
recognizing an attribute and a type of the terminal;
determining whether the communication service is appropriate for the terminal based on the attribute and the type; and
if it is determined that the communication service is appropriate, setting the terminal to an active mode.

2. The method of claim 1, further comprising requesting another terminal of a different type to enter a sleep mode.

3. The method of claim 1, further comprising:
if it is determined that the communication service is not appropriate, setting the terminal to a sleep mode.

4. The method of claim 5, further comprising:
searching for another terminal of a different type; and
transmitting an active-mode setting request signal to the searched terminal.

5. The method of claim 1, wherein the attribute is at least one of: an operation state of the terminal, a type of an application requested for execution, sensed information about a location of the terminal, and a current time.

6. A terminal to receive a communication service, comprising:
an operation recognizer to recognize an attribute and a type of the terminal, and to determine whether the communication service is appropriate for the terminal based on the attribute and the type; and
a mode setter to set the terminal to an active mode if it is determined that the communication service is appropriate.

7. The terminal of claim 6, further comprising:
a short-range communicator to communicate with a second terminal of a different type,
wherein the short-range communicator transmits a sleep-mode setting request signal to the second terminal.

8. The terminal of claim 6, wherein the mode setter sets the terminal to a sleep mode if it is determined that the communication service is not appropriate.

9. The terminal of claim 8, further comprising:
a short-range communicator to communicate with a second terminal of a different type;
a controller to search for the second terminal and to determine if the communication service is appropriate for the second terminal based on the different type,
wherein the short-range communicator transmits an active-mode setting request signal to the second terminal if it is determined that the communication service is appropriate.

10. The terminal of claim 6, wherein the attribute is at least one of: an operation state of the terminal, a type of an application requested for execution, sensed information about a location of the terminal, and a current time.

11. A method for providing a communication service to multiple terminals having a same specific identifier (ID), the method comprising:
receiving a request for providing a communication service to a terminal with the specific ID;
selecting an appropriate terminal amongst the multiple terminals, for the communication service; and
transmitting communication service data to the appropriate terminal.

12. The method of claim 11, further comprising determining whether there is more than one terminal with the specific ID.

13. The method of claim 11, wherein the multiple terminals are in an active mode.

14. The method of claim 11, wherein the selection of the appropriate terminal is based on at least one of: an operation state of the appropriate terminal, a type of an application requested for execution, sensed information about a location of the appropriate terminal, and a current time.

15. A base station apparatus to provide a communication service, comprising:
a database (DB) configured to store information about at least one terminal, each having a specific identifier (ID);
a communicator to communicate the communication service wirelessly with the at least one terminal; and
a controller to select an appropriate terminal among the at least one terminals, if a request for providing a communication service to a terminal with the specific ID is received,
wherein the communicator communicates the communication service to the appropriate terminal.

16. The base station apparatus of claim 15, wherein the controller determines whether there is more than one terminal with the specific ID.

17. The base station apparatus of claim 15, wherein the controller searches for the appropriate terminal to set an active mode.

18. The base station apparatus of claim 15, wherein the controller selects the appropriate terminal based on at least one of: an operation state of the appropriate terminal, a type of an application requested for execution, sensed information about a location of the appropriate terminal, and a current time.

19. The method of claim 12, wherein, if it is determined there is not more than one terminal, bypassing the selecting.

20. The base station apparatus of claim 16, wherein, if the controller determines there is not more than one terminal, the controller skips the selection of the appropriate terminal, and
the communicator communicates the communication service.
